(19) United States
(12) Patent Application Publication
(10) Pub. No.: US 2004/0209509 A1
(43) Pub. Date: Oct. 21, 2004

(54) Connector

(75) Inventors: Toshio Okamura, Funabashi-shi (JP); Toshio Shimoyama, Fujisawa-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Japan Aviation Electronics Industry, Limited, Tokyo (JP)

(21) Appl. No.: 10/723,797

(22) Filed: Nov. 25, 2003

(30) Foreign Application Priority Data
Apr. 18, 2003 (JP) 2003-114427

(51) Int. Cl. H01R 13/627

(52) U.S. Cl. 439/357

(57) ABSTRACT

There is provided a connector which is capable of providing click feeling when the connector is locked to a mating connector. A plug connector 10 is comprised of a barrel 11, and a looking member 12 disposed on the outer peripheral surface of the barrel 11. The locking member 12 is comprised of a locking member body 121 fixed to the barrel 11, a nail portion 122a for engagement with a first annular groove 311a of a receptacle connector 30, and a spring portion 122b for urging the nail portion 122a toward the first annular groove 311a. A stepped portion 119 is formed in the barrel 11, for inhibiting the nail portion 122a from moving more than a predetermined distance when the spring portion 122b is bent using the locking member body 121 as a support, and causing the spring portion 122b to be bent using the nail portion 122a as a support.

### BACKGROUND OF THE INVENTION

1. Field of the Invention

This invention relates to a connector provided with a locking mechanism for holding the connector fitted to a mating connector.

2. Description of the Related Art

Conventionally, as a connector with a locking mechanism, there has been proposed one which includes a connector body, a locking member, and a sleeve (as disclosed e.g. in Japanese Laid-Open Utility Model Publication (Kokai) No. 5-57775).

The connector body is formed to have a hollow cylindrical shape.

The locking member has a hollow cylindrical locking body. The locking body has a plurality of locking pieces axially extending at required intervals along the circumference of the body. The locking pieces have resilient properties such that they can bend in the radial direction of the locking body. Each of the locking pieces has a distal end formed with a locking nail. The locking member is mounted on an outer peripheral surface of the connector body in a manner movable in an axial direction of the connector body.

The sleeve is formed to have a hollow cylindrical shape. The sleeve is mount d on the outer peripheral surface of the connector body in a manner movable in the longitudinal direction of the connector body such that the sleeve covers a coil spring mounted on the outer peripheral surface of the connector body, and the locking body. The coil spring urges the locking member toward a receptacle connector, which is a mating connector.

To connect the connector to the receptacle connector, the connector body is pushed into the receptacle connector with the locking member being pressed against a hollow cylindrical body of the receptacle connector. At this time, the coil spring is compressed and the force applied to the connector body is transmitted to the locking member via the coil spring. As a result, each locking piece is bent toward the connector body to cause its locking nail to enter the receptacle body, whereby the locking nails are brought into contact with an inner peripheral surface of the receptacle body.

When the connector body is further pushed deep into the receptacle connector, the locking nails are axially moved along the inner peripheral surface of the receptacle body, and finally enters a recess formed in the inner peripheral surface of the receptacle body. Thus, the connector is locked to the receptacle connector.

As described above, in the conventional connector, when the connector is fitted to the receptacle connector, the locking nails are axially moved along the inner peripheral surface of the receptacle body only to directly enter the recess. Therefore, the bending amount of each locking piece is small, and the spring force of the locking piece is not largely changed. This makes it difficult to know when the connector is locked to the receptacle connector.

### SUMMARY OF THE INVENTION

It is an object of the present invention to provide a connector which is capable of providing click feeling when the connector is locked to a mating connector.

To attain the above object, the present invention provides a connector for being connected to a mating connector having a recess, comprising:

a housing;

a locking member provided on an outer peripheral surface of the housing, the locking member including a fixed portion fixed to the housing, an engaging portion for engagement with the recess of the mating connector, and a spring portion for urging the engaging portion toward the recess; and

spring force-increasing means for inhibiting the engaging portion from moving more than a predetermined distance when the spring portion is bent using the fixed portion as a support, and causing the spring portion to be bent using the engaging portion as a support.

According to this connector, since the spring force-increasing means is provided, the spring force of the spring portion is dramatically increased immediately before the engaging portion is engaged with the recess, and the spring force of the spring portion is rapidly released when the engaging portion enters the recess, whereby the engaging portion is engaged with the recess with force, so that it is possible to provide click feeling when the connector is locked to the mating connector.

Preferably, the housing has a hollow cylindrical shape, and has an accommodating space formed therein for accommodating the spring portion and the engaging portion when the spring portion is bent, and the connector further comprises a sliding member mounted on an outer peripheral surface of the locking member in a manner slidable in an axial direction of the housing, the sliding member having a window for permitting the engaging portion to escape therein such that the engaging portion can be engaged with the recess of the mating connector when the connector is fitted to the mating connector.

According to this preferred embodiment, the sliding member is mounted on the outer peripheral surface of the locking member in a manner slidable in the axial direction of the housing, and therefore if the sliding member of the connector fitted in the mating connector is pulled, the engaging portion can be pushed into the accommodating space of the housing by the sliding member, whereby the engaging portion and the recess are disengaged from each other. This makes it possible to easily perform unlocking operation.

More preferably, the spring force-increasing means is a stepped portion which is form d in the housing in a manner protruding into the accommodating space.

According to this preferred embodiment, the spring force-increasing means is a stepped portion formed in the housing, and therefore when the bending amount of the spring portion using the fixed portion as a support exceeds a predetermined amount, the engaging portion is brought into contact with the stepped portion, and the spring portion is bent using the engaging portion as a support, whereby the spring force of the spring portion is dramatically increased immediately before the engaging portion is engaged with the recess. This makes it possible to provide click feeling by a simple construction.

Alternatively, the spring force-increasing means is a protruding portion which is formed on a bottom surface of the engaging portion in a manner protruding into the accommodating space.

According to this preferred embodiment, the spring force-increasing means is a protrusion formed on the bottom surface of the engaging portion, and therefore when the bending amount of the spring portion using the fixed portion as a support exceeds a predetermined amount, the protrusion is brought into contact with the bottom of the accommodating space of the housing, and the spring portion is bent using the engaging portion as a support, whereby the spring force of the spring portion is dramatically increased immediately before the engaging portion is engaged with the recess. This makes it possible to provide click feeling by a simple construction.

Alternatively, the spring force-increasing means is a ring which is wound around the housing in a manner opposed to the engaging portion in a radial direction of the housing.

According to this preferred embodiment, the spring force-increasing means is a ring which is wound around the housing in a manner opposed to the engaging portion in the radial direction of the housing, so that when the bending amount of the spring portion using the fixed portion as a support exceeds a predetermined amount, the engaging portion is brought into contact with the ring, and the spring portion is bent using the engaging portion as a support, whereby the spring force of the spring portion is dramatically increased immediately before the engaging portion is engaged with the recess. This makes it possible to provide click feeling by a simple construction.

The above and other objects, features and advantages of the present invention will become more apparent from the following detailed description taken in conjunction with the accompanying drawings.

### BRIEF DESCRIPTION OF THE DRAWINGS

FIG. 1 is a longitudinal cross-sectional view showing a plug connector according to an embodiment of the present invention and a receptacle connector in a state separate from each other;

FIG. 2 is a longitudinal cross-sectional view showing the FIG. 1 plug connector with a front end thereof being inserted into the receptacle connector;

FIG. 3 is a longitudinal cross-sectional view showing the FIG. 1 plug connector in a state locked to the receptacle connector;

FIG. 4 is a longitudinal cross-sectional view of a spring portion of the locking member and component parts associated therewith, appearing in FIG. 1, in a state in which the spring portion is not bent;

FIG. 5 is a longitudinal cross-sectional view of the spring portion of the locking member and component parts associated therewith, appearing in FIG. 1, in a state in which a nail portion of the locking member abuts against a stepped portion of a barrel;

FIG. 6 is a cross-sectional view showing a protrusion, as a variation of spring force-increasing means, formed on a bottom of the nail portion of the locking member appearing in FIG. 1, for abutting a bottom surface of an accommodating space; and

FIG. 7 is a cross-sectional view showing a ring, as another variation of the spring force-increasing means, wrapped around the barrel, with which the nail portion of the locking member is to abut.

### DESCRIPTION OF THE PREFERRED EMBODIMENT

The invention will now be described in detail with reference to the drawings showing a preferred embodiment thereof.

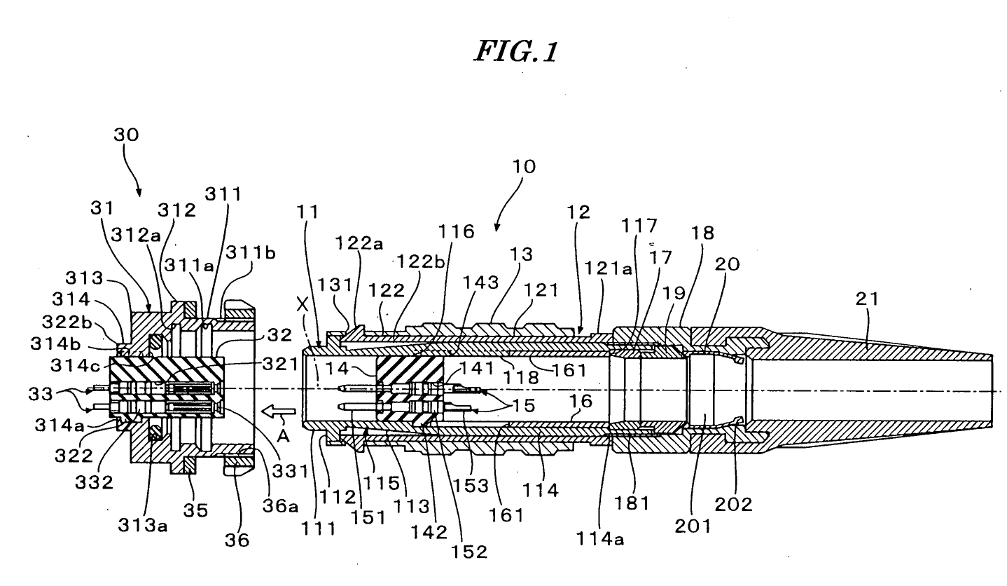

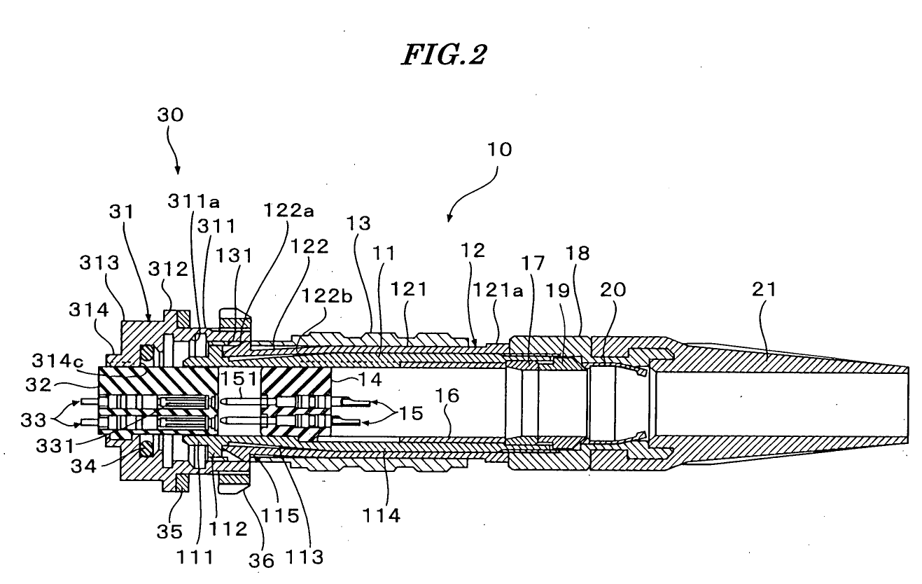

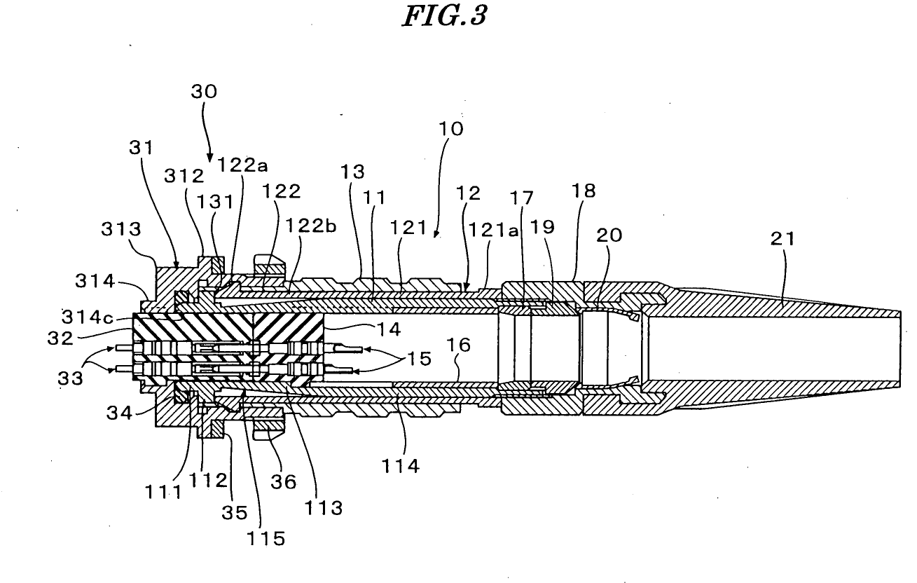

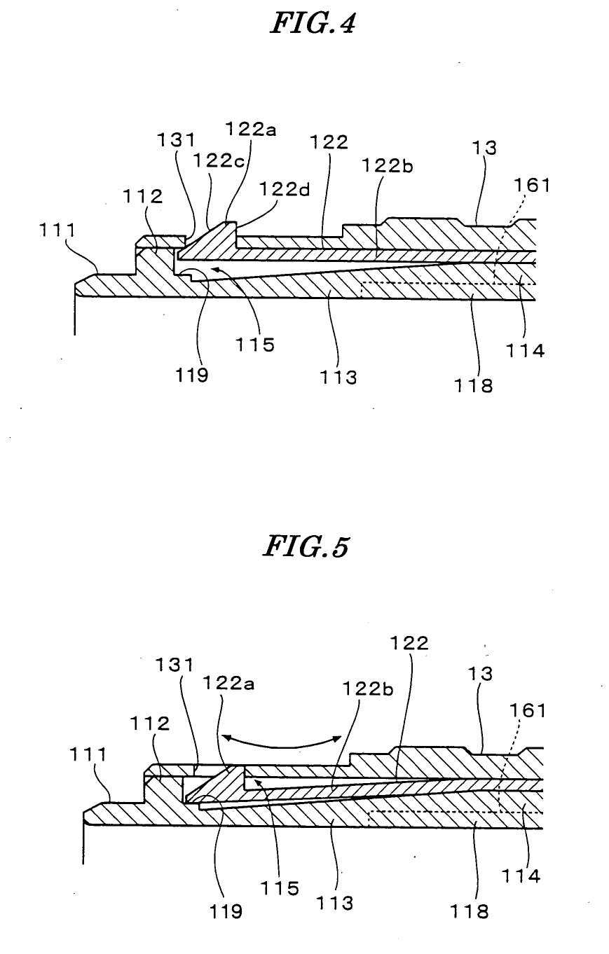

Referring to FIG. 1 to FIG. 5, there is shown a plug connector according to an embodiment of the present invention. FIG. 1 is a longitudinal cross-sectional view showing the plug connector and a receptacle connector in a state separate from each other. FIG. 2 is a longitudinal cross-sectional view showing the plug connector with a front end portion thereof inserted into the receptacle connector. FIG. 3 is a longitudinal cross-sectional view showing the plug connector in a state locked to the receptacle connector. FIG. 4 is a longitudinal cross-sectional view of a spring portion of the locking member and component parts associated therewith, appearing in FIG. 1, in a state in which the spring portion is not bent. FIG. 5 is a longitudinal cross-sectional view of the spring portion of the locking member and component parts associated therewith, appearing FIG. 1, in a state in which a nail portion of the locking member abuts against a stepped portion of a barrel.

As shown in FIG. 1, the plug connector (connector) 10 has one end of a cable, not shown, connected thereto and is to be fitted in the receptacle connector 30 which is a mating connector.

The plug connector 10 is comprised of the barrel (housing) 11, the locking member 12, and a coupling nut (sliding member) 13.

The barrel 11 has a hollow cylindrical shape and is electrically conductive. The barrel 11 includes a small-diameter portion 111, a flange portion 112, a tapered portion 113, and a large-diameter portion 114. The small-diameter portion 111 is located at a front end portion of the barrel 11. The flange portion 112 is continuous with the small-diameter portion 111. The tapered portion 113 is decreased in diameter toward the small-diameter portion 111 and continuous with the flange portion 112. The smallest outer diameter of the tapered portion 113 is smaller than the outer diameter of the small-diameter portion 111, and the largest outer diameter thereof is equal to the outer diameter of the large-diameter portion 114. Between the outer peripheral surface of the tapered portion 113 and an inner peripheral surface of the locking member 12 is defined an accommodating space 115 for accommodating part of locking pieces 122, referred to hereinafter. The large-diameter portion 114 is continuous with the tapered portion 113. The outer diameter of the large-diameter portion 114 is larger than that of the small-diameter portion 111. The large-diameter portion 114 has a rear end thereof formed with a male thread 114a on an outer peripheral surface thereof. The inner peripheral surface of the barrel 11 has three steps, and a first riser surface 116 and a second riser surface 117 are formed at respective boundaries between the steps. Further, the inner peripheral surface of the barrel 11 is formed with a key 118 which extends from the first riser surface 116 toward the second riser surface 117 in parallel with the axial direction X of the barrel 11.

The locking member 12 includes a locking member body (fixed portion) 121 and the locking pieces 122. The locking member body 121 has a hollow cylindrical shape, and has a rear end thereof formed with a flange portion 121a. The locking member body 121 is mounted on the outer peripheral surface of the barrel 11, and fixed on the barrel 11 by being sandwiched by the flange portion 112 of the barrel 11 and a grand nut 18. Each locking piece 122 is form d by forming cuts in the locking member body 121. The locking piece 122 includes the nail portion (engaging portion) 122a, and a spring portion 122b. The nail portion 122a is engaged with a first annular groove (recess) 311a of the receptacle connector 30, referred to hereinafter. Referring to FIG. 4, the nail portion 122a has an inclined surface 122c, and a stopper surface 122d. The inclined surface 122c is inclined with respect to the axial direction X of the barrel 11. The stopper surface 122d is adjacent to the inclined surface 122c, and substantially parallel to the radial direction of the locking member body 121. The spring portion 122b is continuous with the nail portion 122a via one end thereof, and continuous with the locking member body 121 via the other end thereof. The spring portion 122b urges the nail portion 122a toward the first annular groove 311a.

The coupling nut 13 has a hollow cylindrical shape and is mounted on the outer peripheral surface of the locking member 12 in a manner slidable in the axial direction X. The coupling nut 13 has a front end thereof formed with a window 131. The window 131 permits the nail portion 122a to escape therein such that the nail portion 122a can be engaged with the first annular groove 311a when the plug connector 10 is fitted in the receptacle connector 30. The coupling nut 13 is formed with a second window, not shown. The second window is engaged with a protrusion, not shown, formed on the outer peripheral surface of the locking member 12. The second window abuts against the protrusion of the locking member 12, when the coupling nut 13 is caused to slide forward (i.e. toward the receptacle connector 30) by a predetermined amount, whereas when the coupling nut 13 is caused to slide backward by a predetermined amount, the second window permits the protrusion of the locking member 12 to relatively move in the axial direction X. The coupling nut 13, when caused to slide backward, abuts against the flange portion 121a for fixed engagement therewith.

The barrel 11 has an insulator 14, a plurality of contacts 15, a sleeve 16, and a shield sleeve 17, all arranged therein.

The insulator 14 has a generally cylindrical shape, and includes a plurality of contact insertion holes 141, and a flange 142. The flange 142 abuts against the first riser surface 116. Further, the flange 142 has a portion thereof formed with a key groove 143. A key 118 is inserted into the key groove 143 to thereby inhibit the insulator 14 from rotating about the central axis thereof.

The contacts 15 are each comprised of a pin portion 151, a press-fitted portion 152, and a terminal portion 153. The pin portion 151 is inserted into an associated one of socket portions 331 of contacts 33 of the receptacle connector 30, referred to hereinafter, for being brought into contact therewith. The press-fitted portion 152 is press-fitted into an associated one of the contact insertion holes 141. The terminal portion 153 is connected to an electrical wire of a cable.

The cable is comprised of a plurality of electrical wires, a shield for covering the plurality of electrical wires, and a sheath for covering the shield.

The sleeve 16 having a hollow cylindrical shape has a pair of key grooves 161 formed in a front end thereof. Only one of the pair of key grooves 161 is actually used for having the key 118 inserted therein. The front end face of the sleeve 16 is abutted against the flange 142, and the rear end surface thereof is located at substantially the same position as that of the second riser surface 117 in the axial direction X.

The shield sleeve 17 has a generally annular shape and is electrically conductive. The outer peripheral surface of the shield sleeve 17 is in contact with the inner peripheral surface of the barrel 11, while the inner peripheral surface thereof is in contact with the shield of the cable. The front end face of the shield sleeve 17 is abutted against the second riser surface 117 and the rear end face of the sleeve 16.

The barrel 11 has the grand nut 18 mounted on a rear end portion thereof. The grand nut 18 has an inner peripheral surface thereof formed with a female thread 181. The male thread 114a formed on the large-diameter portion 114 of the barrel 11 is screwed into the female thread 181. The grand nut 18 has a front end face thereof abutted against the flange portion 121a of the locking member 12, whereby the locking member 12 is fixed on the barrel 11 by being sandwiched by the flange portion 112 of the barrel 11 and the grand nut 18.

The grand nut 18 contains a rubber member 19 and a clamp 20.

When the grand nut 18 is mounted on the barrel 11, the rubber member 19 is compressed by the shield sleeve 17 and the grand nut 18, for being brought into intimate contact with the cable. Thus, the rubber member 19 prevents water from entering the barrel 11.

The clamp 20 includes an annular portion 201 and a plurality of clamp portions 202. The clamp portions 202 each have a hook-like distal end and are arranged at equal intervals along the circumference of the annular portion 201. When the grand nut 18 is mounted on the barrel 11, the clamp portions 202 are urged by the grand nut 18 to be caused to fall toward the cable, whereby the clamp 20 holds the cable therein.

The grand nut 18 has a boot 21 mounted on a rear end thereof. The boot 21 holds the cable such that the cable is not extremely bent.

Referring to FIG. 4, the tapered portion 113 has a front end thereof formed with a stepped portion 119. As shown in FIG. 5, when the spring portion 122b is bent toward the tapered portion 113, the stepped portion 119 supports the nail portion 122a.

Next, a description will be given of the receptacle connector.

Referring to FIG. 1, the receptacle connector 30 is comprised of a shell 31, an insulator 32, and a plurality of contacts 33.

The shell 31 is electrically conductive, and includes a small-diameter portion 311, a flange portion 312, a large-diameter portion 313, and an insulator-holding portion 314. The small-diameter portion 311 has a hollow cylindrical shape, and is located at a front end portion of the shell 31. The small-diameter portion 311 has an inner peripheral surface thereof formed with the first annular groove 311a, and an outer peripheral surface formed with a male thread 311b. The flange portion 312 is continuous with the small-diameter portion 311. The flange portion 312 has an inner peripheral surface thereof formed with a second annular groove 312a. The large-diameter portion 313 has a hollow cylindrical shape, and is continuous with the flange portion 312. The large-diameter portion 313 has an outer diameter larger than that of the small-diameter portion 311 but smaller than that of the flange portion 312. The large-diameter portion 313 has an inner peripheral surface thereof formed with a third annular groove 313a. The insulator-holding portion 314 is formed at a central portion of the large-diameter portion 313, and holds a flange portion 322 of the insulator 32, referred to hereinafter. The insulator-holding portion 314 is formed with a nail 314a for preventing the insulator 32 from falling off the receptacle connector 30. Further, the insulator-holding portion 314 has an inner peripheral surface thereof integrally formed with a key 314b.

The insulator 32 has a generally cylindrical shape, and includes a plurality of contact insertion holes 321, and a flange portion 322. The flange portion 322 has a portion thereof formed with a key groove 322a. A key 314b is inserted into the key groove 322a to there by inhibit the insulator 32 from rotating about the central axis thereof.

The contacts 33 are each comprised of a socket portion 331, a press-fitted portion 332, and a terminal portion 333. The socket portion 331 receives the pin portion 151 therein. The press-fitted portion 332 is press-fitted into an associated one of the contact insertion holes 321.

The third annular groove 313a has an O ring 34 fitted therein.

The small-diameter portion 311 of the shell 31 has an annular gasket 35 disposed thereon in a manner adjacent to the flange portion 312.

A jam nut 36 is mounted on the small-diameter portion 311. The jam nut 36 is formed with a female thread 36a into which is screwed the male thread 311b formed on the small-diameter portion 311 of the shell 31.

The small-diameter portion 311 is inserted into a hole formed in a panel, not shown, in a state of the jam nut 36 removed therefrom. At this time, the flange portion 312 abuts against the rim of the hole in the panel via the gasket 35. In this state, the jam nut 36 is mounted on the small-diameter portion 311, whereby the receptacle connector 30 is rigidly fixed to the panel.

Next, a description will be given of operations for fitting and removing the plug connector 10 in and from the receptacle connector 30.

First of all, the operator holds the coupling nut 13, and inserts the front end portion of the plug connector 10 into the receptacle connector 30, as indicated by an arrow A in FIG. 1. This causes the nail portion 122a of the plug connector 10 to be abutted against the end face of the small-diameter portion 311 of the receptacle connector 30, and moved toward the tapered portion 113. As the nail portion 122a is moved toward the tapered portion 113, the spring portion 122b is bent.

Further, when the plug connector 10 is inserted deeper into the receptacle connector 30, the nail portion 122a is allowed to enter the small-diameter portion 311, as shown in FIG. 2. At this time, as shown in FIG. 5, the nail portion 122a abuts against the stepped portion 119, and the spring portion 122 is further bent toward the tapered portion 113 such that the nail portion 112a pivots about the stepped portion 119. As a result, the spring portion 122b is largely bent, as indicated by a double-headed arrow in FIG. 5, to thereby increase a spring force of the spring portion 122b.

From the above state, when the plug connector 10 is inserted even deeper into the receptacle connector 30, the nail portion 122a moves along the inner peripheral surface of the small-diameter portion 311, and finally enters the first annular groove 311a of the receptacle connector 30 by the urging force of the spring portion 122b. At this time, since the increased spring force of the spring portion 122b is momentarily released to cause the nail portion 122a to abut against the small-diameter portion 311 with force, the operator can have click feeling.

When the nail portion 122a enters the first annular groove 311a, almost simultaneously with this, the front end face of the small-diameter portion 111 abuts against one end surface 314c (see FIG. 3) of the insulator-holding portion 314, whereby the advance of the plug connector 10 is stopped.

By carrying out the above operation, the pin portions 151 are inserted into the respective associated socket portions 331, whereby the plug connector 10 is fitted to the receptacle connector 30.

To remove the plug connector 10 from the receptacle connector 30 from the above state, first, the coupling nut 13 is drawn backward. Then, one of walls of the coupling nut 13 defining the window 131 urges the nail portion 122a toward the tapered portion 113, whereby the nail portion 122a and the first annular groove 311a are disengaged from each other.

When the coupling nut 13 is further drawn backward, it abuts against the flange portion 121a.

After that, when the coupling nut 13 is drawn backward, the whole plug connector 10 is moved backward to be removed from the receptacle connector 30.

As described hereinabove, according to the present embodiment, the spring force of the spring portion 122b is increased by the stepped portion 119, which provides click feeling when the plug connector 10 is fitted to the receptacle connector 30. Further, it is possible to provide the click feeling by a simple construction, thereby making it possible to prevent manufacturing costs of the plug connector from being increased.

Further, since the coupling nut 13 is provided, the operation for unlocking the plug connector 10 is easy to carry out.

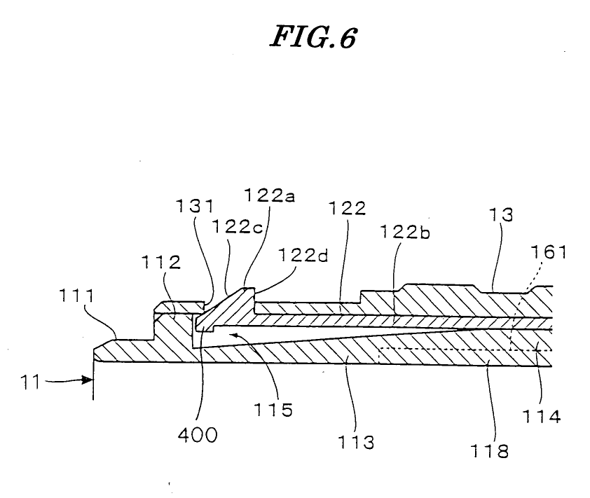

Although in the above described embodiment, the stepped portion 119 is provided in the barrel 11, as spring force-increasing means for increasing the spring force of the spring portion 122b, this is not limitative, but a protrusion 400 may be formed, as a variation of the spring force-increasing means, on the bottom surface of the nail portion 122a, as shown in FIG. 6, for being brought into abutment with a bottom surface of the accommodating space 115 when the bending amount of the spring portion 122b using the locking member body 121 as a support or pivot exceeds a predetermined amount. According to this variation, similarly to the above embodiment, it is possible to provide click feeling when the plug connector 10 is locked by a simple construction.

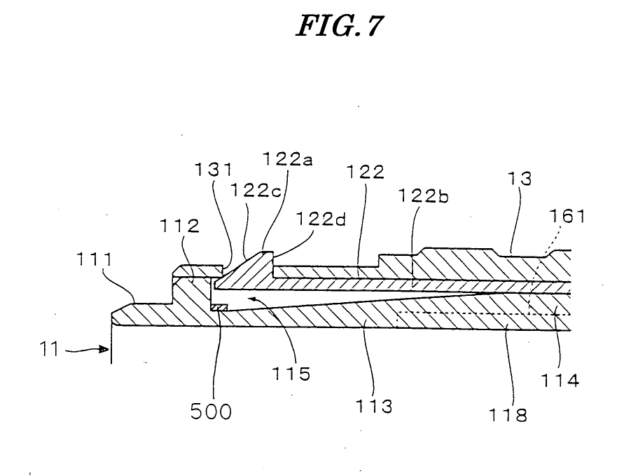

Further, as shown in FIG. 7, a ring 500 opposed to the nail portion 122a in the radial direction of the barrel 11 may be wound around the barrel 11 as another variation of the spring force-increasing means. According to this variation, it is possible to easily adjust the spring force of the spring portion 122b by replacing the ring by another.

Although in the above embodiment, the present invention is applied to the plug connector 10 including the barrel 11, the locking member 12, and the coupling nut 13, this is not limitative, but the present invention can be applied to any connector so long as it is a connector with a locking mechanism, including an engaging portion and a spring portion.

It is further understood by those skilled in the art that the foregoing are the preferred embodiments of the present invention, and that various changes and modification may be made thereto without departing from the spirit and scope thereof.

What is claimed is:

1. A connector for being connected to a mating connector having a recess, comprising:
a housing;
a locking member provided on an outer peripheral surface of said housing, said locking member including a fixed portion fixed to said housing, an engaging portion for engagement with the recess of the mating connector, and a spring portion for urging said engaging portion toward the recess; and
spring force-increasing means for inhibiting said engaging portion from moving more than a predetermined distance when said spring portion is bent using said fixed portion as a support, and causing said spring portion to be bent using said engaging portion as a support.

2. A connector as claimed in claim 1, wherein said housing has a hollow cylindrical shape, and has an accommodating space formed therein for accommodating said spring portion and said engaging portion when said spring portion is bent,
the connector further comprising a sliding member mounted on an outer peripheral surface of said locking member in a manner slidable in an axial direction of said housing, said sliding member having a window for permitting said engaging portion to escape therein such that said engaging portion can be engaged with the recess of the mating connector when the connector is fitted to the mating connector.

3. A connector as claim d in claim 2, wherein said spring force-increasing means is a stepped portion formed in said housing in a manner protruding into said accommodating space.

4. A connector as claimed in claim 2, wherein said spring force-increasing means is a protruding portion formed on a bottom surface of said engaging portion in a manner protruding into said accommodating space.

5. A connector as claimed in claim 2, wherein said spring force-increasing means is a ring which is wound around said housing in a manner opposed to said engaging portion in a radial direction of said housing.
